(19) United States
(12) Patent Application Publication
(10) Pub. No.: US 2010/0164807 A1
(43) Pub. Date: Jul. 1, 2010

(54) SYSTEM AND METHOD FOR ESTIMATING STATE OF CARRIER

(75) Inventors: Kuo-Shih Tseng, Taichung County (TW); Chih-Wei Tang, Taoyuan County (TW); Chin-Lung Lee, Taoyuan County (TW); Chia-Lin Kuo, Taoyuan County (TW); An-Tao Yang, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/398,187

(22) Filed: Mar. 5, 2009

(30) Foreign Application Priority Data
Dec. 30, 2008 (TW) 97151448

(51) Int. Cl. G01S 1/08

(52) U.S. Cl. 342/386; 342/385

(57) ABSTRACT

A system and a method for estimating a state of a carrier are provided. The system includes the carrier, an electromagnetic wave sensing device, a motion sensing device, and a controller. The electromagnetic wave sensing device detects an electromagnetic wave emitted by at least one feature object in an environment around the carrier. The motion sensing device detects motion information of the carrier moving in the environment. The controller estimates state information of the carrier in the environment through a probabilistic algorithm according to the electromagnetic wave and motion information detected by aforementioned sensing devices. Thereby, in the present invention, the location and posture of the carrier in the environment can be precisely estimated according to the motion information of the carrier and existing information of the environment around the same.

### CROSS-REFERENCE TO RELATED APPLICATION

This application claims the priority benefit of Taiwan application serial no. 97151448, filed on Dec. 30, 2008. The entirety of the above-mentioned patent application is hereby incorporated by reference herein and made a part of specification.

### BACKGROUND OF THE INVENTION

1. Field of the Invention

The present invention generally relates to a positioning apparatus and a positioning method, and more particularly, to an apparatus and a method for estimating a state of a carrier.

2. Description of Related Art

Outdoor positioning has been broadly applied to in-car navigation systems since the global positioning system (GPS) is developed by the United States, wherein the position of a vehicle or a person can be precisely determined at any outdoor place where satellite signals can be received. Contrarily, the development of indoor positioning technique is still not so satisfying at this moment, and both the electromagnetic shielding characteristic of buildings and the rapidly changing indoor environment make difficulties in indoor positioning.

Existing indoor positioning techniques may be divided into two groups. According to the first group of indoor positioning techniques, the location of a robot is estimated by detecting the relative relationship between an external sensor and a receiver of the robot. According to the second group of indoor positioning techniques, a laser range finder is disposed in the robot for scanning features in the environment around the robot, and these features are then compared with a built-in map to estimate the location of the robot. The first type of indoor positioning techniques offer high-speed calculation but require external sensors to be established in the environment in advance. The system cannot position a robot properly once these external sensors are moved or shielded. Besides, if a first type indoor positioning technique is applied to a large-scale environment, more sensors have to be deployed and accordingly the cost of the system is increased. On the other hand, the second group of indoor positioning techniques has low-speed calculation but offer high expandability. Accordingly, the system can operate in a changing environment uninterruptedly as long as there are still feature points to be referred to in the environment.

Foregoing second type of indoor positioning techniques is more focused in consideration of the relatively high expandability and low cost thereof. For example, in U.S. Pat. No. 7,015,831, the map location in an environment is estimated through a second type of indoor positioning technique by using a vision sensor and a dead reckoning (DR) device. In U.S. Pat. No. 7,135,992, the 2D posture of a carrier is estimated by using a vision sensor and a DR device. However, in foregoing two patents, the vision sensor may be interfered by light beams and accordingly cannot provide precise positioning result, and besides, none of the two techniques can be applied to 3D space.

### SUMMARY OF THE INVENTION

Accordingly, the present invention is directed to a carrier state estimation method, wherein state information of a carrier is estimated by referring to environment information and motion information of the carrier.

The present invention is also directed to a carrier state estimation system, wherein an electromagnetic wave sensing device detects environment information, a motion sensing device detects motion information of a carrier, a mechanical wave transceiver device detects a mechanical wave, and a digital filter estimates a state of the carrier.

The present invention provides a carrier state estimation method suitable for estimating state information of a carrier. First, an electromagnetic wave emitted by at least one feature object in an environment around the carrier is detected, so as to calculate a relative position between the carrier and the feature object. Meanwhile, motion information of the carrier moving in the environment is detected. Then, the state information of the carrier in the environment is estimated through a probabilistic algorithm according to the relative position and the motion information.

According to an embodiment of the present invention, the step of calculating the relative position between the carrier and the feature object includes following steps. First, a distance between the carrier and the feature object is estimated according to the power or geometric distance of the electromagnetic wave. Then, the relative position between the carrier and the feature object is calculated according to two distances estimated consecutively and the angle of the electromagnetic wave.

According to an embodiment of the present invention, the step of detecting the motion information of the carrier moving in the environment includes detecting posture angles of the carrier corresponding to three coordinate axes. While estimating the state information of the carrier, the posture angles are integrated to obtain the displacement and speed of the carrier corresponding to each coordinate axis. The location and posture of the carrier in the environment are estimated according to the posture angle, the displacement, and the speed of the carrier on each coordinate axis and served as the state information of the carrier in the environment.

According to an embodiment of the present invention, the step of estimating the state information of the carrier in the environment through the probabilistic algorithm according to the relative position and the motion information further includes correcting the location of the carrier in the environment through the probabilistic algorithm according to the relative position between the carrier and the feature object.

According to an embodiment of the present invention, the carrier state estimation method further includes emitting a mechanical wave from the carrier to the environment and receiving the mechanical wave reflected by the feature object in the environment, so as to calculate the relative position between the carrier and the feature object.

The present invention further provides a carrier state estimation system including a carrier, an electromagnetic wave sensing device, a motion sensing device, and a controller. The electromagnetic wave sensing device is disposed in the carrier for detecting an electromagnetic wave emitted by at least one feature object in an environment around the carrier. The motion sensing device is disposed in the carrier for detecting motion information of the carrier in the environment. The controller is also disposed in the carrier and coupled to the electromagnetic wave sensing device and the motion sensing device. The controller calculates the relative position between the carrier and the feature object according to the electromagnetic wave detected by the electromagnetic wave sensing device and estimates state information of the carrier in the environment through a probabilistic algorithm according to the relative position and the motion information.

According to an embodiment of the present invention, the controller includes a quaternion calculation unit, a direction cosine calculation unit, a gravity component extraction unit, an acceleration integration unit, a speed integration unit, a coordinate conversion unit, a data association unit, and a digital filter. The quaternion calculation unit receives the angular displacements of the carrier corresponding to three coordinate axes detected by the motion sensing device and converts the angular displacements into a plurality of operators. The direction cosine calculation unit performs a direction cosine calculation on the operators to obtain the posture angle of the carrier corresponding to each coordinate axis. The gravity component extraction unit calculates the acceleration of the carrier corresponding to each coordinate axis according to the posture angle of the carrier corresponding to the coordinate axis. The acceleration integration unit calculates the speed of the carrier on each coordinate axis according to the acceleration of the carrier on the coordinate axis and the angular displacements of the carrier corresponding to the three coordinate axes of the carrier detected by the motion sensing device. The speed integration unit calculates the displacement of the carrier on each coordinate axis according to the speed of the carrier on the coordinate axis. The coordinate conversion unit converts the coordinate axes of the displacement of the carrier on each coordinate axis into the coordinate axes of the environment. The data association unit calculates the environment feature on each coordinate axis corresponding to the features currently detected by the carrier through data association. The digital filter calculates the posture angle, speed, and displacement of the carrier on each coordinate axis according to the environment feature of the carrier on the coordinate axis, and the digital filter generates a plurality of operators and sends these operators back to the quaternion calculation unit.

According to an embodiment of the present invention, the controller further includes an environment feature calculation unit. The environment feature calculation unit estimates the distance between the carrier and the feature object according to the power or geometric distance of the electromagnetic wave detected by the electromagnetic wave sensing device, and the environment feature calculation unit calculates the relative position between the carrier and the feature object according to two distances estimated consecutively and the angle of the electromagnetic wave, so as to calculate the location and posture of the carrier in the environment.

In the present invention, an electromagnetic wave sensing device, a motion sensing device, and a mechanical wave transceiver device are adopted for detecting the motion information of a carrier and the information of an environment around the carrier, and the location and posture of the carrier in the environment are determined through a multi-sensor fusion state estimation method and served as state information of the carrier.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a carrier state estimation system according to an embodiment of the present invention.

FIG. 2 is a block diagram of a carrier state estimation system according to an embodiment of the present invention.

FIG. 3 is a diagram illustrating image projection in eyes according to an embodiment of the present invention.

FIG. 4(a) and FIG. 4(b) are diagrams illustrating how to detect a distance between a carrier and a feature object in an environment by using an electromagnetic wave sensor to estimate the location of the carrier in the environment according to an embodiment of the present invention.

FIG. 5 is a diagram of a motion sensing device according to an embodiment of the present invention.

FIG. 6 is a block diagram of a controller according to an embodiment of the present invention.

FIG. 7 is a flowchart of a carrier state estimation method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to provide an effective indoor positioning technique and avoid positioning errors caused by light interference, a multi-sensor fusion method is adopted in the present invention, wherein the advantages of different sensors are integrated to offset the disadvantages of each other. For example, our vision is easily affected by light or source-less light. However, the operation of a sonar will not be affected by light or source-less light but by the shape of an object it measures. In the present invention, an electromagnetic wave sensing device, a motion sensing device, and a mechanical wave transceiver device are adopted, and the relative position between a carrier and a feature object in an environment around the carrier is determined through a possibility model. Accordingly, the location and posture of the carrier in the environment can be estimated. Embodiments of the present invention will be described below with reference to accompanying drawings.

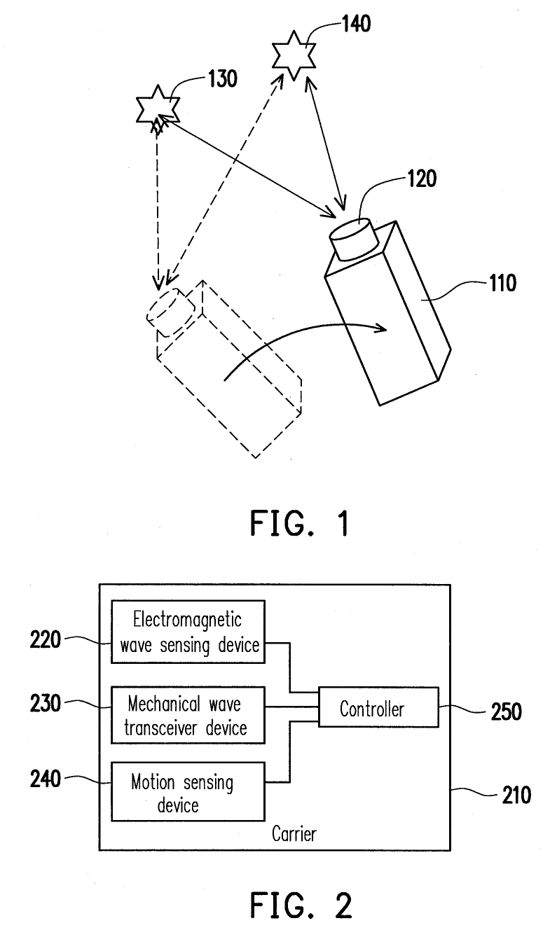

FIG. 1 is a schematic diagram of a carrier state estimation system according to an embodiment of the present invention. Referring to FIG. 1, in the present embodiment, the carrier state estimation system includes a carrier 110 and a multi-sensor module 120. The carrier 110 may be an automobile, a motorcycle, a bicycle, a robot, or other movable objects; however, the scope of the carrier 110 is not limited in the present invention.

The multi-sensor module 120 includes a motion sensing device, an electromagnetic wave sensing device, and a mechanical wave transceiver device. The motion sensing device detects motion information (for example, speed, acceleration, angular speed, and angular acceleration) of the carrier 110. The electromagnetic wave sensing device detects an electromagnetic wave (for example, an image or other invisible electromagnetic waves) to calculate the relative position between the carrier 110 and feature objects 130 and 140 in the environment. The mechanical wave transceiver device emits a mechanical wave (a shock wave produced through mechanical shock, such as a sonar) to detect the feature objects 130 and 140 in the environment. With foregoing sensing devices, the multi-sensor module 120 can detect the environment information and motion information of the carrier and provide the information to a controller (not shown). The controller can then obtain the state information of the carrier 110 in the environment through a probabilistic algorithm.

According to the present invention, the controller analyzes the information detected by foregoing sensing devices to estimate the location and posture of the carrier in the environment. FIG. 2 is a block diagram of a carrier state estimation system according to an embodiment of the present invention. Referring to FIG. 2, in the present embodiment, the carrier state estimation system includes a carrier 210, an electromagnetic wave sensing device 220, a mechanical wave transceiver device 230, a motion sensing device 240, and a controller 250. The controller 250 is connected to the other devices and can estimate state information of the carrier 210 according to information detected by these other devices. Below, the functions of these elements will be respectively described.

The electromagnetic wave sensing device 220 includes a sensor, such as a vision sensor or an ultrasound sensor. Due to the maturity of complementary metal oxide semiconductor (CMOS) techniques, the cost of vision sensor is greatly reduced and accordingly it is presently the most commonly adopted sensor. The technique for establishing objects and environment in a space through images has been developed for many years in the computer vision field. However, because image analysis errors may be caused by ambient light and noise interferences and the number of local feature points may bring estimation difficulties, a machine cannot precisely interpret the scenery disposition in an image with a high-level semantic viewpoint as a human does, or the calculation complexity thereof has to be increased to achieve more precise calculation results. These problems are to be resolved in order to position objects in the real world by using images.

For example, when an object in the real world is to be positioned by using an image sensor, if an internal parameter matrix and an external parameter matrix of a camera are already known, a parameter matrix of the camera can be obtained based on these internal and external parameters. Noise removal, illumination correction, and image rectification, can be selectively performed to two images captured by two different cameras or by the same camera before and after a time interval, wherein a fundamental matrix has to be provided if the image rectification is performed. The calculation of the matrix will be described in detail below.

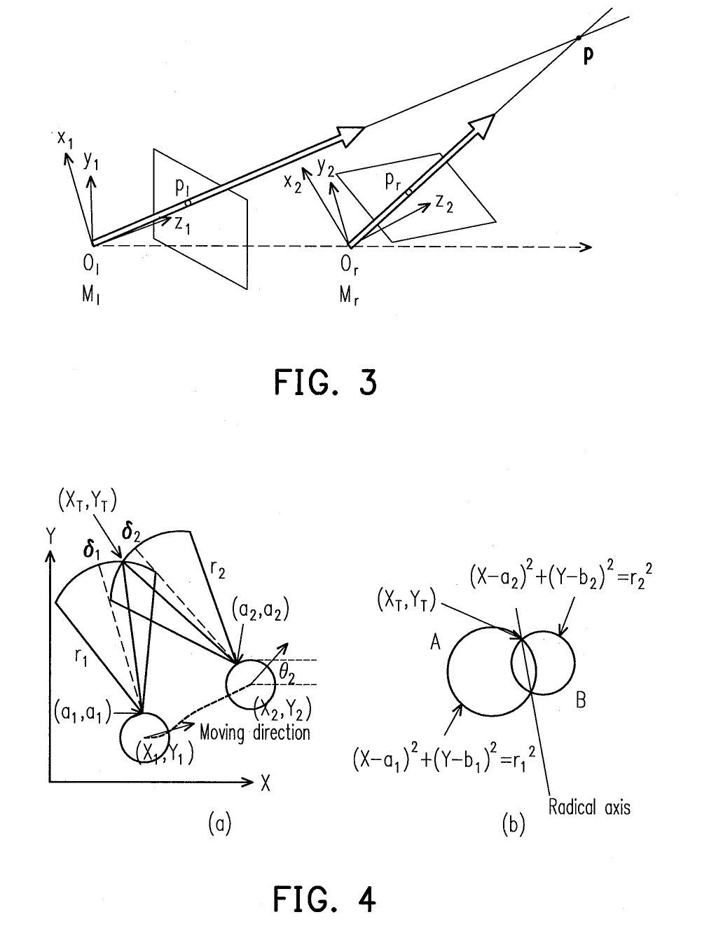

FIG. 3 is a diagram illustrating image projection in vision sensors according to an embodiment of the present invention. Referring to FIG. 3, because a imaging point in an image expressed with the coordinates system of the camera can be converted through the parameter matrix in the camera, the imaging point can be expressed on a 2D image plane as:

pₗMₗ⁻¹ p̅ₗ (1)

pᵣ=Mᵣ⁻¹ p̅ᵣ (2)

wherein pₗ and pᵣ respectively represent the imaging point of an object P in the real world within a first image and a second image and which are expressed with the coordinates system of the camera; p̅ₗ and p̅ᵣ respectively represent the imaging point of the object P in the first image and the second image but which are expressed with the coordinates system of the 2D image plane; and Mₗ and Mᵣ respectively represent the internal parameter matrix of the first camera and the second camera. Besides, pₗ and pᵣ can be converted through an essential matrix E, wherein E represents the multiplication result of the rotation and shift matrixes between the coordinates systems of the two cameras, and accordingly:

pᵣ^{T}Epₗ=0 (3)

By respectively replacing pₗ and pᵣ in foregoing expression with p̅ₗ and p̅ᵣ, there is:

(Mᵣ⁻¹ p̅ᵣ)^{T}E(Mₗ⁻¹ p̅ₗ)=0 (4)

By combining Mₗ, Mᵣ, and E, there is:

p̅ᵣ^{T}(Mᵣ^{-T}EMₗ⁻¹) p̅ₗ=0 (5)

Then, the following is brought in:

F=Mᵣ^{-T}RSMₗ⁻¹ (6)

to get the relationship between the two cameras as:

p̅ᵣ^{T}F p̅ₗ=0 (7)

Accordingly, the fundamental matrix can be obtained by bringing several sets of corresponding points in the two images into foregoing expression. The corrected images have corresponding parallel epipolar lines.

Thereafter, feature extraction is performed to the corrected images to extract meaningful feature points or areas which are to be compared. Then the features are simplified into feature descriptors through image description. Next, stereo matching is performed to the features in the images to find out the corresponding feature descriptors in the two images. For example, assuming that the coordinates of the features pₗ and pᵣ are respectively [u^{l} v^{l}]^{T} and [u^{r} v^{r}]^{T}, because the images contain noises, the world coordinates of the feature point P in the space can be estimated by resolving the optimization problem in 3D reconstruction, as following:

$${min}_{P} {\sum }_{j = l , r} [ {( \frac{{m}_{1}^{jT} P}{{m}_{3}^{jT} P} - {u}^{j} )}^{2} + {( \frac{{m}_{2}^{jT} P}{{m}_{3}^{jT} P} - {v}^{j} )}^{2} ] \qquad ( 8 )$$

wherein m₁^{jT}, m₂^{jT}, m₃^{jT} respectively represent the first, second, and third row of the parameter matrix of the camera.

On the other hand, an electromagnetic wave sensor can detect an electromagnetic wave emitted by a plurality of feature objects in an indoor environment. The controller 250 can calculate the relative position between the feature objects and the carrier and accordingly the location of the carrier in the environment by analyzing the power of the electromagnetic wave. To be specific, the following function can be constructed by detecting the waveforms, frequencies, and powers of different electromagnetic waves by using the electromagnetic wave sensor:

$$E ( r ) = K \frac{1}{{r}^{2}} \qquad ( 9 )$$

wherein E(r) represents an electromagnetic wave power function, K is a constant, and r represents the distance between a carrier and a feature object. The distance between the feature object and the carrier can be obtained through analysis of the powers of the electromagnetic waves, and then, the problem can be simplified into a problem of finding common points of two circles based on two distances obtained before and after the movement of the carrier and the location information of the same.

In addition, an ultrasound sensor is a range-only sensor. Namely, the ultrasound sensor can only detect an object within a certain range but cannot obtain the precise location of the object. The distance between the feature object and the carrier can be obtained through analysis of the power, the geometric distance, or the time difference between transmission and reception of the mechanical wave. Then, the problem may also be simplified into a problem of finding common points of two circles based on two distances obtained before and after the movement of the carrier and the location information of the same.

FIG. 4(a) and FIG. 4(b) are diagrams illustrating how to detect a distance between a carrier and a feature object in an environment by using an electromagnetic wave sensor to estimate the location of the carrier in the environment according to an embodiment of the present invention. First, referring to FIG. 4(a), it is assumed that the location of the carrier is (X₁, Y₁) at time k and (X₂, Y₂) at time k+1, wherein the difference between time k and time k+1 is Δt, and Δt is a constant sampling time. The mechanical wave sensor moves from location (a₁, b₁) to location (a₂, b₂) from time k to time k+1. The distances r₁ and r₂ between the feature object in the environment which emits the mechanical wave and the carrier are then estimated according to the power of the mechanical wave detected by the mechanical wave sensor or the time difference between the transmission and reception of the mechanical wave at these two locations. Next, the circles A and B as shown in FIG. 4(b) are respectively drawn with the locations (a₁, b₁) and (a₂, b₂) of the mechanical wave sensor as the centers and the distances r₁ and r₂ as the radii. The circles A and B can be expressed as:

Circle A: (X−a₁)²+(Y−b₁)²=r₁² (10)

Circle B: (X−a₂)²+(Y−b₂)²=r₂² (11)

The cross points between the circles A and B are connected by a radical axis, and the radical axis can be expressed as following based on foregoing expressions of the circles A and B:

$$Y = \frac{- ( 2 {a}_{2} - 2 {a}_{1} )}{( 2 {b}_{2} - 2 {b}_{1} )} X - \frac{( {a}_{1}^{2} + {b}_{1}^{2} + {r}_{2}^{2} - {a}_{2}^{2} - {b}_{2}^{2} - {r}_{1}^{2} )}{( 2 {b}_{2} - 2 {b}_{1} )} \qquad ( 12 )$$

Then, the relationship between the cross points (X_{T}, Y_{T}) of the circles A and B is assumed to be:

Y_{T}=mX_{T}+n (13)

By bringing foregoing expression (13) into the expression (10) of the circle A, there is:

(X_{T}−a₁)²+(mX_{T}+n−b₁)²=r₁² [symbol] (m²+1)X_{T}²+(2mn−2mb₁−2a₁)X_{T}+(n−b₁)²+a₁²−r₁²=0

Next, it is assumed that P=m²+1, Q=2mn−2mb₁−2a₁, and

$$R = {( n - {b}_{1} )}^{2} + {a}_{1}^{2} - {r}_{1}^{2} , there is \text{:} \\ {X}_{T} = \frac{- Q \pm \sqrt{{Q}^{2} - 4 PR}}{2 P} \\ {Y}_{T} = \frac{m ( - Q \pm \sqrt{{Q}^{2} - 4 PR} )}{2 P} + n \qquad ( 14 )$$

Two sets of solutions of the (X_{T}, Y_{T}) are obtained through foregoing derivations. Then, which solution is the location of the feature object can be determined by referring to the angle of the electromagnetic wave.

It should be mentioned that the mechanical wave transceiver device is also a range-only sensor. Namely, the mechanical wave transceiver device can only detect a carrier within a certain range but cannot obtain the precise location of the carrier. The mechanical wave transceiver device may be implemented with a device which produces shock wave through mechanical shock, such as an ultrasound, an ultrasound array, or a sonar. In order to measure the location of a carrier by using a mechanical wave, in the present embodiment, the location of the feature object is simplified into a problem of finding common points of two circles by using two mechanical wave distances detected before and after a movement of the carrier and the location information of the carrier. The method for finding the common points of the two circles is similar to that of the electromagnetic wave sensor therefore will not be described herein.

The motion sensing device 240 is usually used for measuring motion information of the carrier which performs a linear or rotational movement. The motion sensing device 240 may be implemented with an accelerometer, a gyroscope, or a rotational speed sensor. The controller 250 analyzes the information detected by the motion sensing device 240 through a special algorithm to obtain movement information (for example, location, speed, acceleration, angle, angular speed, and angular acceleration, etc) of the carrier in a 3D space.

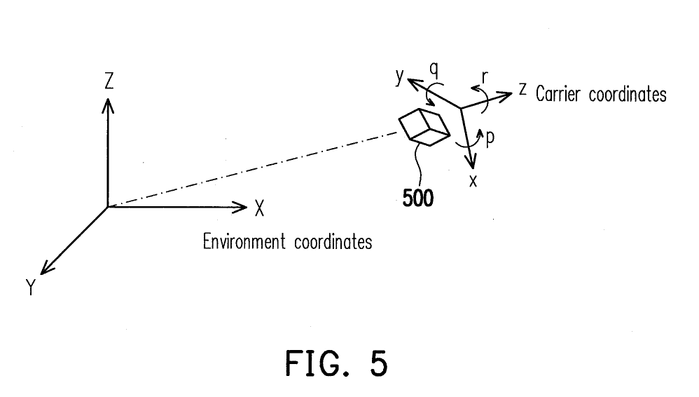

FIG. 5 is a diagram of a motion sensing device according to an embodiment of the present invention. Referring to FIG. 5, in the present embodiment, a motion sensing device 500 obtains the angular displacements p, q, and r of a carrier corresponding to three coordinate axes (axis x, axis y, and axis z) of the carrier. The motion sensing device 500 may be implemented with an accelerometer, a gyroscope, or a rotational speed sensor.

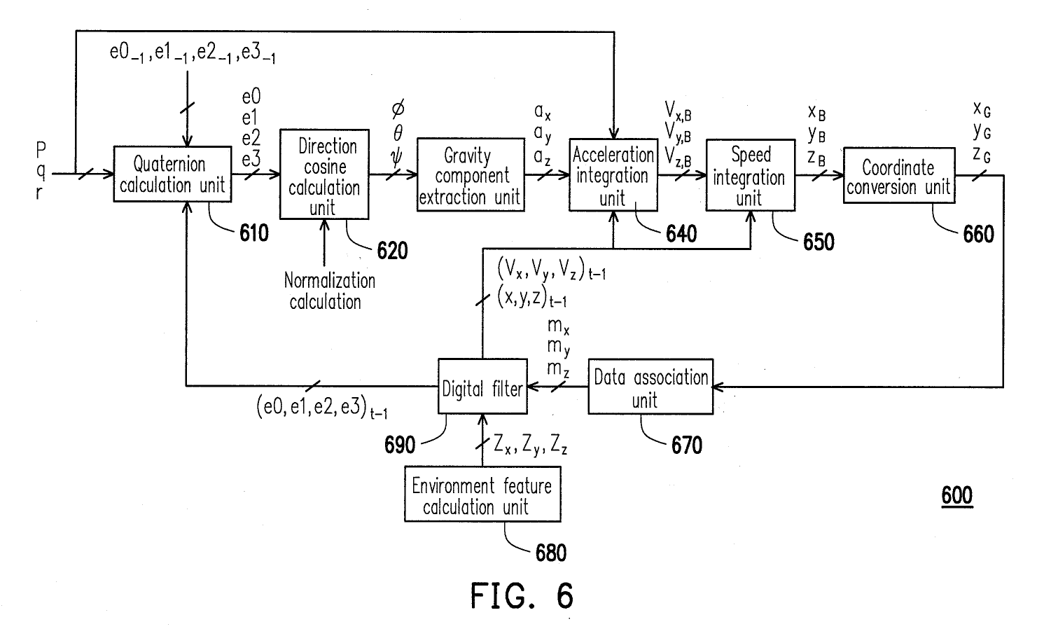

The motion information detected by the motion sensing device 500 is sent to a controller (not shown). The controller analyzes the motion information to estimate state information of the carrier in an environment. FIG. 6 is a block diagram of a controller according to an embodiment of the present invention. Referring to both FIG. 5 and FIG. 6, in the present embodiment, the controller 600 includes a quaternion calculation unit 610, a direction cosine calculation unit 620, a gravity component extraction unit 630, an acceleration integration unit 640, a speed integration unit 650, a coordinate conversion unit 660, a data association unit 670, an environment feature calculation unit 680, and a digital filter 690. Below, the functions of these elements will be respectively described.

The quaternion calculation unit 610 receives the angular displacements p, q, and r from the motion sensing device 500 and initializes operators e0₋₁, e1₋₁, e2₋₁, and e3₋₁, so as to convert the angular displacements p, q, and r into operators e0, e1, e2, and e3.

The direction cosine calculation unit 620 then performs a direction cosine calculation and a normalization to the operators e0, e1, e2, and e3 to obtain posture angles θ, φ, and ψ of the carrier corresponding to the axes x, y, and z.

The gravity component extraction unit 630 calculates accelerations aₓ, a_{y}, and a_{z} of the carrier corresponding to the coordinate axes according to the posture angles θ, φ, and ψ of the carrier corresponding to the coordinate axes output by the direction cosine calculation unit 620.

The acceleration integration unit 640 calculates speeds V_{x,B}, V_{y,B}, and V_{z,B} of the carrier on the coordinate axes according to the accelerations aₓ, a_{y}, and a_{z} of the carrier corresponding to the coordinate axes output by the gravity component extraction unit 630 and the angular displacements p, q, and r of the carrier corresponding to the three coordinate axes of the carrier detected by the motion sensing device 500.

The speed integration unit 650 calculates displacements x_{B}, y_{B}, and z_{B} of the carrier on the coordinate axes according to the speeds V_{x,B}, V_{y,B}, and V_{z,B} of the carrier on the coordinate axes output by the acceleration integration unit 640.

The coordinate conversion unit 660 converts the coordinate axes of the displacements x_{B}, y_{B}, and z_{B} of the carrier on the axes x, y, and z output by the speed integration unit 650 into coordinate axes (i.e., axis X, axis Y, and axis Z) of the global coordinate, so as to obtain the displacements x_{G}, y_{G}, and z_{G}.

The data association unit 670 is coupled to the coordinate conversion unit 660 and receives the displacements x_{G}, y_{G}, and z_{G} of the carrier on the coordinate axes from the coordinate conversion unit 660, and the data association unit 670 calculates environment features mₓ, m_{y}, and m_{z} on the coordinate axes corresponding to the features zₓ, z_{y}, and z_{z} currently detected by the carrier.

On the other hand, the environment feature calculation unit 680 estimates the distance between the carrier and each of the feature objects according to the power or geometric distance of the electromagnetic wave detected by the electromagnetic wave sensing device, and determines the relative position between the carrier and each of the feature objects based on two distances estimated consecutively and the angle of the electromagnetic wave, so as to calculate locations Zₓ, Z_{y}, and Z_{z} of the carrier in the environment.

If the speeds and displacements of the carrier are only calculated based on the motion information, the accumulated error produced when the speeds and displacements are integrated will result in a large deviation between the final estimated value and the actual value. In this case, this error has to be corrected through a probabilistic algorithm by adopting other types of sensors.

The digital filter 690 may be a Kalman filter, a particle filter, or a Bayesian filter. The digital filter 690 receives the locations Zₓ, Z_{y}, and Z_{z} of the carrier in the environment from the environment feature calculation unit 680 and receives the environment features mₓ, m_{y}, and m_{z} of the carrier on the coordinate axes from the data association unit 670. The digital filter 690 corrects the displacements x_{G}, y_{G}, and z_{G} of the carrier on the axes X, Y, and Z through the probabilistic algorithm to obtain corrected speeds v_{x,t-1}, v_{y,t-1}, and v_{z,t-1}, corrected displacements xₜ₋₁, yₜ₋₁, and zₜ₋₁, and feedback operators e0ₜ₋₁, e1ₜ₋₁, e2ₜ₋₁, and e3ₜ₋₁. The digital filter 690 sends the speeds v_{x,t-1}, v_{y,t-1}, and v_{z,t-1} and the displacements xₜ₋₁, yₜ₋₁, and zₜ₋₁, back to the acceleration integration unit 640 and the speed integration unit 650 and sends the operators e0ₜ₋₁, e1ₜ₋₁, e2ₜ₋₁, and e3ₜ₋₁ back to the quaternion calculation unit 610. The current location and posture of the carrier can be instantly updated through foregoing recursive process.

A carrier state estimation method is provided by the present invention corresponding to the carrier state estimation system described above, and below, this method will be described in detail with reference to an embodiment of the present invention.

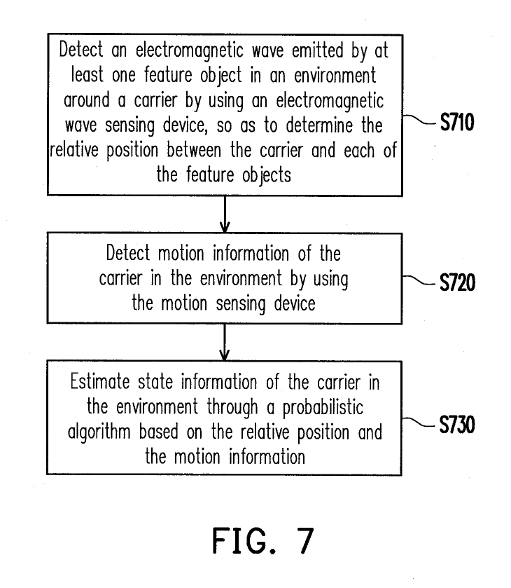

FIG. 7 is a flowchart of a carrier state estimation method according to an embodiment of the present invention. Referring to FIG. 7, in the present embodiment, environment information and motion information of a carrier are obtained by using foregoing electromagnetic wave sensing device, motion sensing device, and mechanical wave transceiver device, so as to estimate state information of the carrier. Steps of the carrier state estimation method in the present embodiment will be described in detail below.

First, an electromagnetic wave emitted by at least one feature object in the environment around the carrier is detected by using the electromagnetic wave sensing device, so as to determine the relative position between the carrier and each of the feature objects (step S710). To be specific, the distance between the carrier and the feature object is first estimated according to the power of the electromagnetic wave detected by the electromagnetic wave sensing device, and the relative position between the carrier and the feature object is then determined according to two distances estimated consecutively and the angle of the electromagnetic wave. The detailed method for determining the relative position between the carrier and the feature object has been described in detail in foregoing embodiment therefore will not be described herein.

It should be mentioned that before the location of the feature object is actually estimated, a map of the environment around the carrier may be first obtained so that the displacement of the feature object in the environment before and after the carrier moves can be obtained, and accordingly the state information of the carrier in the environment can be estimated. To be specific, in an embodiment of the present invention, the electromagnetic wave may be detected before and after a time interval so that two image information of the environment is obtained. After that, noise removal, illumination correction, image rectification, feature extraction, image description, and eye comparison are performed to the image information. Finally, the location information of the feature object in the environment is calculated according to the image information, so as to establish the map of the environment, wherein the map records the location information of each feature object in the environment.

Next, motion information of the carrier in the environment is detected by using the motion sensing device (step S720). The motion sensing device may be an accelerometer, a gyroscope, or a rotational speed sensor, and the motion information includes speed, acceleration, angular speed, or angular acceleration.

Finally, the state information of the carrier in the environment is estimated through a probabilistic algorithm based on the relative position and the motion information (step S730). To be specific, the motion sensing device detects the posture angles of the carrier corresponding to three coordinate axes and then performs coordinate conversion and integration on the posture angles to obtain the displacement and speed of the carrier corresponding to each coordinate axis. Then, the location and posture of the carrier in the environment are estimated according to these posture angles, displacements, and speeds, and the location and posture of the carrier are served as the state information of the carrier in the environment.

It should be noted that in order to prevent the accumulated error produced during the integration process from affecting the accuracy of the final estimated value, in the present embodiment, the location of the carrier in the environment is further corrected through the probabilistic algorithm according to the relative position between the carrier and the feature object.

On the other hand, if the electromagnetic wave sensing device cannot detect any feature object in the environment (for example, a visible light beam can pass through glass, but the location of the glass cannot be determined), in the present embodiment, a mechanical wave is further emitted by the mechanical wave transceiver device to the environment, and the mechanical wave reflected by each feature object in the environment is received to determine the relative position between the carrier and the feature object. The approach for determining the location of the feature object by using the mechanical wave is the same as that by using the electromagnetic wave therefore will not be described herein. Those feature objects (for example, glass) which cannot be detected by the electromagnetic wave sensing device become detectable with the help of the mechanical wave, and accordingly the carrier state estimation is made more accurate.

In the carrier state estimation method provided by the present invention, a state equation of the entire system can be implemented with a digital filter. In the present application, the state to be estimated is the location xₜ=[xₜ, yₜ, zₜ, θₜ, φₜ, ψₜ] of the carrier in the space, which is expressed as:

xₜ=f(xₜ₋₁, uₜ)+εₜ (15)

zₜ=h(xₜ)+δₜ (16)

wherein xₜ represents the current space state which contains the location (x,y,z) and the posture (θ,φ, ψ) of the carrier, xₜ₋₁ represents a previous space state, and uₜ represents current motion information of the carrier, such as accelerations (aₓ, a_{y}, a_{z}) and angular speeds (ωₓ, ω_{y}, ω_{z}) etc. zₜ represents the environment information currently detected by a sensor, such as (r, φ₁, ψ₁) xₜ can be obtained by a Kalman filter, a particle filter, or a Bayesian filter through iteration. The current xₜ is output to other devices, and the state information of the carrier is provided to other devices.

For example, assuming the motion model of the carrier is Xₜ=g(Xₜ₋₁, Uₜ)+εₜ, then the state of the carrier is:

Xₜ=[X_{G,t} V_{x,t} A_{x,t} Y_{G,t} V_{y,t} A_{y,t} Z_{G,t} V_{z,t} A_{z,t} e_{0,t} e_{1,t} e_{2,t} e_{3,t}]^{T} (17)

wherein [X_{G,t} Y_{G,t} Z_{G,t}]^{T} is the absolute location of the carrier in the world coordinates; [V_{x,t} V_{y,t} V_{z,t}]^{T} is the speed of the carrier in the carrier coordinates; [A_{x,t} A_{y,t} A_{z,t}]^{T} is the acceleration of the carrier in the carrier coordinates; [e_{0,t} e_{1,t} e_{2,t} e_{3,t}]^{T} is the quaternion of the carrier in the carrier coordinates; and Uₜ=[a_{x,t} a_{y,t} a_{z,t} ω_{x,t} ω_{y,t} ω_{z,t}]^{T} is the accelerations and angular speeds of the carrier in the carrier coordinates.

To calculate the absolute location of the carrier at time t in the world coordinates, the integrated information of the accelerations and angular speeds of the carrier at time t−1 has to be obtained by using an accelerometer and a gyroscope, and the information in the carrier coordinates has to be converted into information in the world coordinates by using the quaternion. If foregoing steps are completed all together in the motion model, the matrix calculation thereof is expressed as:

$$[ \begin{matrix}{X}_{G , t} \\ {V}_{x , t} \\ {A}_{x , t} \\ {Y}_{G , t} \\ {V}_{y , t} \\ {A}_{y , t} \\ {Z}_{G , t} \\ {V}_{z , t} \\ {A}_{z , t} \\ {e}_{0 , t} \\ {e}_{1 , t} \\ {e}_{2 , t} \\ {e}_{3 , t}\end{matrix} ] = [ \begin{matrix}1 & {R}_{11} t & 0.5 {R}_{11} {t}^{2} & 0 & {R}_{12} t & 0.5 {R}_{12} {t}^{2} & 0 & {R}_{13} t & 0.5 {R}_{13} {t}^{2} & 0 & 0 & 0 & 0 \\ 0 & 1 & 0 & 0 & {ω}_{z , t} & 0 & 0 & - {ω}_{y , t} & 0 & 0 & 0 & 0 & 0 \\ 0 & 0 & 0 & 0 & 0 & 0 & 0 & 0 & 0 & 0 & 0 & 0 & 0 \\ 0 & {R}_{21} t & 0.5 {R}_{21} {t}^{2} & 1 & {R}_{22} t & 0.5 {R}_{22} {t}^{2} & 0 & {R}_{23} t & 0.5 {R}_{23} {t}^{2} & 0 & 0 & 0 & 0 \\ 0 & {ω}_{z , t} & 0 & 0 & 1 & 0 & 0 & {ω}_{x , t} & 0 & 0 & 0 & 0 & 0 \\ 0 & 0 & 0 & 0 & 0 & 0 & 0 & 0 & 0 & 0 & 0 & 0 & 0 \\ 0 & {R}_{31} t & 0.5 {R}_{31} {t}^{2} & 0 & {R}_{32} t & 0.5 {R}_{32} {t}^{2} & 1 & {R}_{33} t & 0.5 {R}_{33} {t}^{2} & 0 & 0 & 0 & 0 \\ 0 & {ω}_{y , t} & 0 & 0 & - {ω}_{x , t} & 0 & 0 & 1 & 0 & 0 & 0 & 0 & 0 \\ 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 1 & - 0.5 {ω}_{z , t} t & - 0.5 {ω}_{y , t} t & - 0.5 {ω}_{z , t} \\ 0 & 0 & 0 & 0 & 0 & 0 & 0 & 0 & 0 & 0.5 {ω}_{x , t} t & 1 & 0.5 {ω}_{y , t} t & - 0.5 {ω}_{z , t} t \\ 0 & 0 & 0 & 0 & 0 & 0 & 0 & 0 & 0 & 0.5 {ω}_{y , t} t & - 0.5 {ω}_{z , t} t & 1 & 0.5 {ω}_{x , t} t \\ 0 & 0 & 0 & 0 & 0 & 0 & 0 & 0 & 0 & - 0.5 {ω}_{z , t} t & 0.5 {ω}_{y , t} t & 0.5 {ω}_{x , t} t & 1\end{matrix} ] [ \begin{matrix}{X}_{G , t - 1} \\ {V}_{x , t - 1} \\ {A}_{x , t - 1} \\ {Y}_{G , t - 1} \\ {V}_{y , t - 1} \\ {A}_{y , t - 1} \\ {Z}_{G , t - 1} \\ {V}_{z , t - 1} \\ {A}_{z , t - 1} \\ {e}_{0 , t - 1} \\ {e}_{1 , t - 1} \\ {e}_{2 , t - 1} \\ {e}_{3 , t - 1}\end{matrix} ] + [ \begin{matrix}0 \\ ( {a}_{x , t} - {g}_{x , t} ) t \\ ( {a}_{x , t} - {g}_{x , t} ) \\ 0 \\ ( {a}_{y , t} - {g}_{y , t} ) t \\ ( {a}_{y , t} - {g}_{y , t} ) \\ 0 \\ ( {a}_{z , t} - {g}_{z , t} ) t \\ ( {a}_{z , t} - {g}_{z , t} ) \\ 0 \\ 0 \\ 0 \\ 0\end{matrix} ] + {ɛ}_{t} \qquad ( 18 )$$

wherein g_{x,t} represents a component of the gravity acceleration on the carrier coordinate axis x; g_{y,t} represents a component of the gravity acceleration on the carrier coordinate axis y; g_{z,t} represents a component of the gravity acceleration on the carrier coordinate axis z; εₜ represents noises produced by the sensor; and R₁₁˜R₃₃ represents parameters in the direction cosine matrix.

In addition, the locations [X_{G,t} Y_{G,t} Z_{G,t}]^{T} of the carrier in the space, the accelerations [A_{x,t} A_{y,t} A_{z,t}]^{T} speeds [V_{x,t} V_{y,t} V_{z,t}]^{T} of the carrier in the carrier coordinates, and the quaternion [e_{0,t} e_{1,t} e_{2,t} e_{3,t} ]^{T} of the carrier can be calculated through the motion model:

$$\begin{matrix}[ \begin{matrix}{x}^{′} \\ {y}^{′} \\ {z}^{′}\end{matrix} ] = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] \\ = [ \begin{matrix}{e}_{0}^{2} + {e}_{1}^{2} - {e}_{2}^{2} - {e}_{3}^{2} & 2 ( {e}_{1} {e}_{2} + {e}_{0} {e}_{3} ) & 2 ( {e}_{1} {e}_{3} - {e}_{0} {e}_{2} ) \\ 2 ( {e}_{1} {e}_{2} - {e}_{0} {e}_{3} ) & {e}_{0}^{2} - {e}_{1}^{2} + {e}_{2}^{2} - {e}_{3}^{2} & 2 ( {e}_{2} {e}_{3} + {e}_{0} {e}_{1} ) \\ 2 ( {e}_{1} {e}_{3} + {e}_{0} {e}_{2} ) & 2 ( {e}_{2} {e}_{3} - {e}_{0} {e}_{1} ) & {e}_{0}^{2} - {e}_{1}^{2} - {e}_{2}^{2} + {e}_{3}^{2}\end{matrix} ] \\ [ \begin{matrix}x \\ y \\ z\end{matrix} ]\end{matrix} \qquad ( 19 )$$

After the state of the carrier is obtained, the state is corrected since it still contains noises produced by the accelerometer and the gyroscope. In the present embodiment, another sensor is adopted as a sensor model to correct the state estimated by the accelerometer and the gyroscope. The sensor model can be generally expressed as:

Zₜ=h(Xₜ)+δₜ (20)

If the sensor is a vision sensor, the sensor model thereof is expressed as:

$$[ \begin{matrix}{z}_{x , t} \\ {z}_{y , t} \\ {z}_{z , t}\end{matrix} ] = {h}_{c , t} ( {x}_{t} ) + {δ}_{c , t} = [ \begin{matrix}{m}_{x , t}^{i} - {X}_{G , t} \\ {m}_{y , t}^{i} - {Y}_{G , t} \\ {m}_{z , t}^{i} - {Z}_{G , t}\end{matrix} ] + {δ}_{c , t} \qquad ( 21 )$$

wherein [m_{x,t}ⁱ m_{y,t}ⁱ m_{z,t}ⁱ]^{T} represents the space coordinates of the i^{th} built-in map, and δ_{c,t} represents the noise produced by the vision sensor.

Additionally, if the sensor is a sonar or an electromagnetic wave sensor, the sensor model thereof is expressed as:

$$\begin{matrix}{z}_{r , t} = {h}_{s , t} ( {x}_{t} ) + {δ}_{s , t} \\ = \sqrt{{( {m}_{x , t}^{i} - {X}_{G , t} )}^{2} + {( {m}_{y , t}^{i} - {Y}_{G , t} )}^{2} + {( {m}_{z , t}^{i} - {Z}_{G , t} )}^{2}} + {δ}_{s , t}\end{matrix} \qquad ( 22 )$$

wherein δ_{s,t} represents the noise produced by the sonar sensor or the electromagnetic wave sensor.

The location of the carrier in the space can be obtained based on foregoing sensor models, and accordingly the state of the carrier estimated according to the motion models can be corrected, wherein the state to be estimated includes the locations [X_{G,t} Y_{G,t} Z_{G,t}]^{T} in the space and the quaternion [e_{0,t} e_{1,t} e_{2,t} e_{3,t}]^{T}. Besides, the angle θ corresponding to the axis X, the angle ψ corresponding to the axis Y, and the angle φ corresponding to the axis Z can be calculated based on the quaternion, as expressed below:

$$\{ \begin{matrix}sin θ = 2 ( {e}_{0} {e}_{2} - {e}_{3} {e}_{1} ) \\ tan ψ = \frac{2 ( {e}_{0} {e}_{3} + {e}_{1} {e}_{2} )}{{e}_{0}^{2} + {e}_{1}^{2} - {e}_{2}^{2} - {e}_{3}^{2}} \\ tan φ = \frac{2 ( {e}_{0} {e}_{1} + {e}_{2} {e}_{3} )}{{e}_{0}^{2} - {e}_{1}^{2} - {e}_{2}^{2} + {e}_{3}^{2}}\end{matrix} \qquad ( 23 )$$

Foregoing motion models and sensor models can be brought into a Bayesian filter, such as a Kalman filter, a particle filter, a Rao-Blackwellised particle filter, or other type of Bayesian filters to estimate the location of the carrier.

If the carrier does not rotate but only shifts its positions, only xₜ=[X_{G,t} Y_{G,t} Z_{G,t}]^{T} is estimated; if the carrier does not move but only rotates, only xₜ=[e_{0,t} e_{1,t} e_{2,t} e_{3,t}]^{T} or the converted xₜ=[θ ψ φ]^{T} is estimated. Both these two cases are within the scope of the present embodiment.

As described above, in the carrier state estimation method and system provided by the present invention, the information detected by an electromagnetic wave sensing device, a motion sensing device, and a mechanical wave transceiver device is integrated, and the relative position between the carrier and a feature object in the environment is determined by a controller through a probabilistic algorithm. Thereby, the problem of indoor positioning error caused by light interference is effectively resolved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A carrier state estimation method, suitable for estimating state information of a carrier, the carrier state estimation method comprising:
detecting an electromagnetic wave emitted by at least one feature object in an environment around the carrier, so as to calculate a relative position between the carrier and each of the feature objects;
detecting motion information of the carrier moving in the environment; and
estimating the state information of the carrier in the environment through a probabilistic algorithm according to the relative position and the motion information.

2. The carrier state estimation method according to claim 1, wherein before the step of detecting the electromagnetic wave emitted by the feature object in the environment, the carrier state estimation method further comprises:
obtaining a map of the environment, wherein the map comprises location information of the feature object in the environment.

3. The carrier state estimation method according to claim 2, wherein the step of obtaining the map of the environment comprises:
detecting the electromagnetic wave before and after a time interval to obtain two image information of the environment; and
calculating location information of the feature object in the environment by using the image information, so as to establish the map of the environment.

4. The carrier state estimation method according to claim 3, wherein after the step of obtaining the image information of the environment, the method further comprises:
performing one or a combination of noise removal, illumination correction, image rectification, feature extraction, image description, and eye comparison to the image information.

5. The carrier state estimation method according to claim 1, wherein the step of calculating the relative position between the carrier and each of the feature objects comprises:
estimating a distance between the carrier and the feature object according to a power or a geometric distance of the detected electromagnetic wave; and
calculating the relative position between the carrier and the feature object according to two of the distances estimated consecutively and an angle of the electromagnetic wave.

6. The carrier state estimation method according to claim 1, wherein the step of detecting the motion information of the carrier moving in the environment comprises:
detecting posture angles of the carrier corresponding to three coordinate axes.

7. The carrier state estimation method according to claim 6, wherein the step of estimating the state information of the carrier in the environment through the probabilistic algorithm according to the relative position and the motion information comprises:
integrating the posture angles to calculate a displacement and a speed of the carrier corresponding to each of the coordinate axes; and
determining a location and a posture of the carrier in the environment according to the posture angle, the displacement, and the speed of the carrier on each of the coordinate axes and serving the location and the posture of the carrier as the state information of the carrier in the environment.

8. The carrier state estimation method according to claim 7, wherein the step of estimating the state information of the carrier in the environment through the probabilistic algorithm according to the relative position and the motion information further comprises:
correcting the location of the carrier in the environment through the probabilistic algorithm according to the relative position between the carrier and the feature object.

9. The carrier state estimation method according to claim 1, wherein the motion information comprises a speed, an acceleration, an angular speed, or an angular acceleration.

10. The carrier state estimation method according to claim 1 further comprising:
emitting a mechanical wave from the carrier to the environment, and receiving the mechanical wave reflected by the feature object in the environment, so as to calculate the relative position between the carrier and the feature object.

11. The carrier state estimation method according to claim 10, wherein the step of calculating the relative position between the carrier and the feature object comprises:
estimating a distance between the carrier and the feature object according to a power or a geometric distance of the mechanical wave reflected by the feature object in the environment; and
calculating the relative position between the carrier and the feature object by using two of the distances estimated consecutively and an angle of the mechanical wave.

12. A carrier state estimation system, comprising:
a carrier;
an electromagnetic wave sensing device, disposed in the carrier, for detecting an electromagnetic wave emitted by at least one feature object in an environment around the carrier;
a motion sensing device, disposed in the carrier, for detecting motion information of the carrier moving in the environment; and
a controller, disposed in the carrier and coupled to the electromagnetic wave sensing device and the motion sensing device, for estimating state information of the carrier in the environment through a probabilistic algorithm according to the electromagnetic wave and the motion information.

13. The carrier state estimation system according to claim 12 further comprising:
a storage unit, disposed in the carrier, for recording a map of the environment and providing the map to the controller for estimating the state information, wherein the map comprises location information of the feature object in the environment.

14. The carrier state estimation system according to claim 13, wherein the electromagnetic wave sensing device detects the electromagnetic wave before and after a time interval to obtain two image information of the environment, and the controller calculates the location information of the feature object in the environment by using the image information so as to establish the map of the environment.

15. The carrier state estimation system according to claim 12, wherein the controller comprises:
a quaternion calculation unit, for receiving angular displacements of the carrier corresponding to three coordinate axes of the carrier detected by the motion sensing device and converting the angular displacements into a plurality of operators;
a direction cosine calculation unit, for performing a direction cosine calculation on the operators to obtain a posture angle of the carrier corresponding to each of the coordinate axes;
a gravity component extraction unit, for calculating an acceleration of the carrier corresponding to each of the coordinate axes according to the posture angle of the carrier corresponding to the coordinate axis;
an acceleration integration unit, for calculating a speed of the carrier on each of the coordinate axes according to the acceleration of the carrier corresponding to the coordinate axis and the angular displacements of the carrier corresponding to the three coordinate axes of the carrier detected by the motion sensing device;
a speed integration unit, for calculating a displacement of the carrier on each of the coordinate axes according to the speed of the carrier on the coordinate axis;
a coordinate conversion unit, for converting the coordinate axes of the displacement of the carrier into the coordinate axes of the environment;
a data association unit, for calculating a plurality of environment features on the coordinate axes corresponding to features currently detected by the carrier according to the displacement of the carrier on each of the converted coordinate axes through data association; and
a digital filter, for calculating a posture angle, a speed, and a displacement of the carrier on each of the coordinate axes according to the environment features of the carrier on the coordinate axis, and generating a plurality of operators and sending the operators back to the quaternion calculation unit.

16. The carrier state estimation system according to claim 15, wherein the controller further comprises:
an environment feature calculation unit, for estimating a distance between the carrier and the feature object according to a power or a geometric distance of the electromagnetic wave detected by the electromagnetic wave sensing device, and calculating the relative position between the carrier and the feature object by using two of the distances estimated consecutively and an angle of the electromagnetic wave, so as to calculate a location and a posture of the carrier in the environment.

17. The carrier state estimation system according to claim 16, wherein the digital filter further corrects the displacement of the carrier on each of the coordinate axes through a probabilistic algorithm according to the location and the posture of the carrier in the environment calculated by the environment feature calculation unit.

18. The carrier state estimation system according to claim 15, wherein the digital filter further sends the speed and the displacement of the carrier on each of the coordinate axes back to the acceleration integration unit and the speed integration unit.

19. The carrier state estimation system according to claim 15, wherein the digital filter comprises a Kalman filter, a particle filter, or a Bayesian filter.

20. The carrier state estimation system according to claim 12 further comprising:
a mechanical wave transceiver device, disposed in the carrier, for emitting a mechanical wave from the carrier to the environment and receiving the mechanical wave reflected by the feature object in the environment.

21. The carrier state estimation system according to claim 20, wherein the controller calculates the state information of the carrier in the environment according to the mechanical wave received by the mechanical wave transceiver device.

22. The carrier state estimation system according to claim 21, wherein the mechanical wave transceiver device comprises an ultrasound, an ultrasound array, or a sonar.

23. The carrier state estimation system according to claim 12, wherein the electromagnetic wave sensing device comprises a visible light vision sensor, an invisible light vision sensor, an electromagnetic wave sensor, or an infrared sensor.

24. The carrier state estimation system according to claim 12, wherein the motion sensing device comprises an accelerometer, a gyroscope, or a rotational speed sensor.

25. The carrier state estimation system according to claim 12, wherein the carrier comprises an automobile, a motorcycle, a bicycle, or a robot.
